(19) United States
(12) Patent Application Publication
(10) Pub. No.: US 2005/0123465 A1
(43) Pub. Date: Jun. 9, 2005

(54) Mesoporous compound comprising a mineral phase of aluminum and cerium, titanium or zirconium oxide particles and, optionally, an element in solid solution in said particles, the preparation method thereof and uses of same

(75) Inventor: Jean-Yves Chane-Ching, Eaubonne (FR)

Correspondence Address: Jean Louis Seugnet;Intellectual Property Department, Rhodia Inc CN7500, 259 Prospect Plains Road, Cranbury, NJ, 08512-7500, US

(73) Assignee: Rhodia, Inc.

(21) Appl. No.: 10/504,628

(22) PCT Filed: Feb. 11, 2003
(86) PCT No.: PCT/FR03/00435

(30) Foreign Application Priority Data
Feb. 15, 2002 (FR) 02/01924
Apr. 12, 2002 (FR) 02/04599

(51) Int. Cl. B01J 23/00; C01B 33/02

(52) U.S. Cl. 423/349; 502/304; 502/350

(57) ABSTRACT

The invention relates to an ordered mesoporous or mesostructured compound comprising a mineral phase of aluminium in which at least partially crystalline particles of a cerium, titanium or zirconium compound are dispersed. The inventive compound is characterised in that the chemical consistency thereof is such that the heterogeneity domains are at most 100 nm² The invention also relates to the aforementioned ordered mesoporous or mesostructured compound which comprises at least one element M in solid solution in said particles. Moreover, the invention relates to the methods of preparing said ordered mesoporous or mesostructured compounds. The inventive materials can be used, for example, in the field of catalysis.

A subject of the present invention is a homogeneous mesostructured compound comprising a mineral phase of alumina, and particles of cerium, titanium or zirconium oxide.

The invention also relates to said ordered mesoporous or mesostructured compound which comprises at least one element M in solid solution in said particles.

The invention also relates to the processes for preparing said ordered mesoporous or mesostructured compounds.

In the strict sense of the term, what are called mesoporous compounds are solids having, within their structure, pores possessing an intermediate size between that of micropores of zeolites-type materials and that of macroscopic pores.

More precisely, the expression “mesoporous compounds” basically describes a compound which specifically comprises pores with an average diameter comprised between 2 and 50 nm, described by the term “mesopores”. Typically, these compounds are amorphous silicas-type or paracrystalline compounds in which the pores are generally distributed in random fashion, with a very wide pore-size distribution.

Regarding the description of such compounds, reference can in particular be made to Science, vol. 220, pp. 365-371 (1983) or also to the Journal of Chemical Society, Faraday Transactions, 1, vol. 81, pp. 545-548 (1985).

On the other hand, what are called “structured” compounds are for their part compounds having an organized structure, and characterized more precisely by the fact that they have at least one diffusion peak in a radiation-diffusion diagram of the X-ray or neutron-diffusion type. Such diffusion diagrams as well as the method for obtaining them are in particular described in Small Angle X-Rays Scattering (Glatter and Kratky—Academic Press London—1982).

The diffusion peak observed in this type of diagram can be associated with a repetition distance characteristic of the compound considered, which in the remainder of the present description will be called the “spatial repetition period” of the structured system.

On the basis of these definitions, by “mesostructured compound” is meant a structured compound possessing a spatial repetition period comprised between 2 and 50 nm. The organized structure present in such a material will here be called the “mesostructure”.

Ordered mesoporous compounds for their part constitute a particular case of mesostructured compounds. These are in fact mesoporous compounds which have an organized spatial arrangement of the mesopores present in their structure, and which therefore effectively possess a spatial repetition period associated with the appearance of a peak in a diffusion diagram.

Ordered mesoporous or mesostructured compounds comprising a mineral phase are well known and are very useful, in particular in the field of catalysis, absorption chemistry or membrane separation.

In particular ordered mesoporous or mesostructured compounds comprising a mineral phase of alumina, within which at least partially crystalline particles of a cerium, titanium or zirconium compound are dispersed, are very useful in the field of catalysis. Also, in order to best adapt them to these different applications, attempts have been made to modify them in so as to improve their effectiveness in these different fields.

Ordered mesoporous or mesostructured compounds comprising a mineral phase of alumina within which mineral particles are dispersed are not in fact perfectly chemically homogeneous, and consequently do not fully meet industrial requirements.

An object of the invention is also to propose ordered mesoporous or mesostructured compounds comprising a mineral phase of alumina, within which mineral particles are dispersed, said mesostructured compound having a good chemical homogeneity and optionally comprising at least one element M in solid solution in said particles.

To this end the present invention proposes according to a first variant an ordered mesoporous or mesostructured compound comprising a mineral phase of alumina, within which at least partially crystalline particles of a cerium, titanium or zirconium compound are dispersed, characterized in that it has a chemical homogeneity such that the heterogeneity domains are at most 100 nm².

The invention also proposes a process for preparing said compound.

The advantage of the compounds according to the present invention is that in addition to their great homogeneity these compounds are thermally stable up to temperatures of approximately 600° C. and even up to temperatures above 700° C. This stability is measured by comparisons with the surface of a compound previously calcined at 500° C. By this is meant that when the compound is subjected to a heat treatment for 6 hours at the above-mentioned temperatures, in addition to the preservation of the mesostructured character, a relatively good maintenance of the specific surface area is observed, that is to say that, following the heat treatment, the specific BET surface area of said compound does not generally vary by a factor exceeding 60%, this factor preferably remaining below or equal to 50%, and advantageously below or equal to 40%. The variation factor of the BET surface area referred to is calculated by the ratio (Si-Sf)/(Si), where “Si” describes the specific BET surface area measured after heat treatment at 500° C.; and where “Sf” describes the specific BET surface area measured after heat treatment at 600° C. or 700° C.

Moreover, a need also exists for materials with further improved properties, for example for materials having an improved reducibility.

Attempts have been made to obtain what are called “doped” materials of this type, that is to say comprising a metal element in the oxide particle, other than the metal element forming said particle, in solid solution within the crystalline network of said particle. In fact, although it is currently known how to synthesize metal oxide particles of very small dimensions (in particular of the cerium oxide, titanium oxide, zirconium oxide type, of dimensions smaller than 10 nm), on the other hand it is known neither how to dope such particles by incorporating in them metal elements in solid solution, or directly synthesize doped oxides in the form of particles with sufficiently small dimensions and/or with a suitable surface area in order that their use in a texturing process results in the obtaining of a thermally stable mesostructure in a phase of alumina.

A second object of the present invention is the obtaining of such what are called “doped” materials that meet these needs.

To this end the present invention proposes according to a second variant an ordered mesoporous or mesostructured compound comprising a mineral phase of alumina, within which at least partially crystalline particles of a cerium, titanium or zirconium compound are dispersed, said compound having a chemical homogeneity such that the heterogeneity domains are at most 100 nm², characterized in that the particles comprise at least one element M in solid solution in said particles.

The invention also proposes a process for preparing said doped compound.

It was thus demonstrated that, unexpectedly, the integration of doping metal cations in solid solution in particles of a mesostructured material can be carried out at a relatively low temperature.

Moreover, the doped materials of the invention advantageously have a stabilized specific surface area, high oxygen storage capacity (OSC) and improved reducibility.

In addition, the advantage of the compounds according to this second variant of the invention is that in addition to their great homogeneity, these compounds are thermally stable up to temperatures of approximately 600° C. and even up to temperatures above 650° C.

This stability is measured as indicated above by comparisons with the surface area of a compound previously calcined at 500° C.

Other advantages and characteristics of the present invention will become clear on reading the following description and examples given purely by way of illustration and non-limitatively.

By specific surface area is meant, for the whole of the description, the specific BET surface area determined by nitrogen adsorption according to the ASTM standard D 3663-78 established on the basis of the BRUNAUER-EMMETT-TELLER method described in the periodical “The Journal of the American Chemical Society, 60, 309 (1938)”.

Firstly, according to a first variant, a subject of the invention is an ordered mesoporous or mesostructured compound comprising a mineral phase of alumina, within which at least partially crystalline particles of a cerium, titanium or zirconium compound are dispersed, characterized in that it has a chemical homogeneity such that the heterogeneity domains are at most 100 nm².

As regards the mineral phase or matrix of alumina, by alumina is meant aluminium hydroxides Al(OH)₃, aluminium oxyhydroxides AlO(OH) or aluminium oxides Al₂0₃. At least partially crystalline particles of a cerium, titanium or zirconium compound are dispersed within this mineral phase. These cerium, titanium, zirconium particles are particles of nanometric dimension.

It will be noted here that the mineral phase or matrix does not embrace all of the particles of nanometric dimension that it contains. In this case, the mineral phase acts as a binder between the particles, at least part of the surface area of which is thus accessible and released from the mineral phase. Thus, at least some of the particles are in contact with the porous parts constituting the internal space, accessible by a gas phase in particular, of the material. Therefore, in the remainder of the description, the term “binding phase” will sometimes be used in relation to the mineral phase.

By “particles of nanometric dimension” is meant, within the meaning of the present invention, particles preferably of spherical or isotropic morphology, at least 50% of the population of which possesses an average diameter comprised between 1 and 10 nm and preferably at most 6 nm, with a preferably monodisperse granulometric distribution of these particles. Here and for the remainder of the description, the sizes of the particles are measured by transmission electron microscopy (TEM).

In particular, the term “particles of nanometric dimension” can also describe according to the invention strongly anisotropic rod-type particles, provided that, for at least 50% of the population of these particles, the average transverse diameter is comprised between 1 and 10 nm and the length does not exceed 100 nm, with a preferably monodisperse granulometric distribution of these particles.

Preferably, the particles dispersed within the alumina matrix are particles with a diameter of the order of 3 to 5 nm. The cerium, titanium or zirconium compounds of the particles are chiefly oxides.

It will also be noted that the binding mineral phase can itself also be constituted by a collection of particles of nanometric dimension. In this case, the particles of alumina preferably have a diameter smaller than that of the particles of the cerium, titanium or zirconium compounds, for example from 1 to 5 nm.

Therefore, as regards the structure of the compound of the invention, the latter has mineral walls which can be described as constituted by discrete domains of binding phase and particles of nanometric dimension. Advantageously, the mineral walls can be constituted by domains of binding phase possessing a smaller thickness compared with the thickness of the domains of the particles of nanometric dimension.

These mineral walls delimit a pore volume with accessibility of the surface areas of the particles of nanometric dimension of the cerium, zirconium or titanium compound by a gas phase or a liquid phase.

The particles of nanometric dimensions based on the compounds of the elements cerium, titanium or zirconium which are present in the material of the invention are at least partially crystalline particles, within which the metal oxide generally has a degree of crystallinity preferably ranging from 30 to 100% by volume. The degree of crystallinity by volume of a given metal oxide, present within the particles of nanometric dimensions of the material of the invention, can be calculated by the ratio of the area of the diffraction peak measured by X-ray diffraction for a sample of the compound according to the invention to the area of the same diffraction peak measured for a control sample of said oxide in the totally crystallized state, adjusted for the absorption coefficients of the corresponding oxides.

The presence of these partially crystallized particles within the mineral phase confers upon the mesostructured compounds or materials of the invention, in addition to an ordered arrangement of their network of pores, an overall degree of crystallinity generally at least equal to 10% by volume, and preferably at least 30% by volume, this overall degree of crystallinity by volume being calculated by multiplying the degree of crystallinity by volume determined experimentally for the particles, according to the method described above, by the fraction by volume of the material which is occupied by said particles. More particularly still, the compound according to the present invention has an overall degree of crystallinity by volume of at least 50% and still more preferably of at least 60%.

By “degree of crystallinity of a mesostructured material” within the meaning of the invention is meant the degree of crystallinity specific to the walls of the structure, which overall takes into account both any crystallinity of the mineral phase of alumina or binding phase and the crystallinity of the particles of nanometric dimensions included in this binding phase. In this connection, it must therefore be stressed that the crystallinity of the material, within the meaning of the invention, corresponds to a microscopic organization detectable in particular by diffraction (for example by wide-angle X-ray diffraction), which is to be distinguished in particular from the order presented, at a more macroscopic level, by the mesostructure of the material.

The mineral phase of the mesostructured material of the present invention integrating the particles of nanometric dimension defined previously for its part constitutes a mineral phase, amorphous to partially crystalline, constituted by alumina.

More particularly said compound has a chemical homogeneity such that the heterogeneity domains are at most 25 nm².

By chemical homogeneity such that the heterogeneity domains are at most x nm² is meant a compound which has a chemical homogeneity over a surface area of at least x nm². For example by chemical homogeneity such that the heterogeneity domains are at most 100 nm² is meant a compound which has a chemical homogeneity over a surface area of at least 10 nm×10 nm on ultramicrotomic sections. This means that there is no difference in the chemical composition of the products of the invention between different surface areas of 100 nm².

These homogeneity characteristics are determined by TEM-EDS analysis. More particularly, the heterogeneity domain was measured by the energy-dispersion-spectroscopy (EDS) cartography method using a transmission electron microscopy (TEM) microprobe on ultramicrotomic sections. These analyses were carried out with a microscope equipped with a 300 KV source (to be confirmed) and the ultramicrotomic sections possess a thickness of 80 nm, plus or minus 20 nm.

According to a second variant of the invention, the material of the invention can contain a doping element. This element can be an element M according to a first embodiment, and/or M′ according to a second embodiment. The element M is in solid solution in the particle constituting the material, i.e. in the cerium, zirconium and/or titanium oxide. This element M is in the cationic state, generally in solid insertion and/or substitution solution, within the crystalline structure of the particle.

By element in solid solution within the particle is meant the presence of this element as cation, in the capacity of insertion and/or substitution cation, within the crystalline oxide of the particle characteristically playing the role of a host crystalline network, said cation of the element M generally representing strictly less than 50 mol-% of the total quantity of metal cations present in the oxide, i.e. the cation integrated in solid solution is preferably a minority cation relative to the cations constituting the metal oxide where it is integrated in solid solution, the level of this cation in the element M however being able to reach 50% in certain cases. A crystalline oxide integrating cations in solid solution preserves the structure of the crystalline oxide in the pure state, slight modifications to the parameters of meshes being observable however, for example in accordance with Vegard's Law. A crystalline oxide integrating cations in solid solution therefore generally has an X-ray-diffraction diagram similar to that of the pure mixed oxide, with a greater or lesser peaks shift.

Generally, the element M is chosen from the rare earths and transition metals, capable of being integrated in cationic form in solid solution within said particle. However, the metal M can be chosen more specifically depending on the nature of the metal oxide of the particle within which it is integrated in solid solution. It will be noted that the quantity of metal M that can be introduced in solid solution within the oxide depends on the nature of said metal M and on the nature of the element constituting said oxide.

Thus, when the particle is constituted by cerium oxide, the element M present in solid solution can, generally, be chosen from the rare earths other than cerium. In this case, the metal M can be more particularly lanthanum, yttrium, neodymium, praseodymium, dysprosium or europium. The element M can also be chosen from the transition metals capable of being integrated in cationic form in solid solution within an oxide of cerium, in particular zirconium, manganese and titanium. When the doping metal M represents zirconium or a rare earth other than cerium, the quantity of cations of the metal M that can be integrated in solid solution can represent a value such that the molar ratio M/Ce is at most 1. When the doping metal M represents titanium, the quantity of titanium that can be integrated in solid solution can represent a value such that the molar ratio Ti/Ce is at most 0.5.

When the particle is constituted by zirconium oxide, the metal M present in solid solution can be chosen from cerium and rare earths other than cerium. In this case, M can advantageously be cerium, lanthanum, yttrium, neodymium, praseodymium, dysprosium or europium. M can also be chosen from transition metals capable of being integrated in cationic form in solid solution within a zirconium oxide. When the doping metal M represents cerium or another rare earth, the quantity of cations of the metal M that can be integrated in solid solution can represent a value such that the molar ratio M/Zr is at most 1.

When the particle is constituted by titanium oxide, the metal M present in cationic state in solid solution can also be chosen from rare earths, transition metals capable of being integrated in solid solution within a titanium oxide. The metal M can be more particularly manganese, tin, vanadium, niobium, molybdenum or antimony.

Finally, according to a particular embodiment, the element M is chosen from cerium, titanium, zirconium, manganese, lanthanum, praseodymium and neodymium, said element M being different from the element constituting the oxide of the particle (cerium, zirconium or titanium oxide).

According to a second more particular embodiment of the second variant of the invention, the compound is characterized in that said particles of the compound include at least one element M′ at least in part on their surface.

This element M′ can be manganese, or an alkali or alkaline earth metal.

This element M′ can be in the form of metal cations and/or clusters based on the metal M′ or on an alkali or alkaline earth metal and/or crystallites of these same elements, these cations or clusters or crystallites being dispersed, preferably homogeneously, at least in part in the surface of the oxide particle constituting the material, or even the whole surface.

By alkali is meant an element of Group IA of the periodic table.

The periodic table of the elements referred to here and in the remainder of the description is that published in the Supplement to the Bulletin of the Société Chimique de France no. 1 (January 1966).

Of the alkalis, sodium or potassium can more particularly be mentioned.

By alkaline earth is meant an element of Group IIA of the periodic table. This can in this case more particularly be barium.

Finally, the element M′ can be manganese.

Of course, this particular embodiment of the second variant of the invention covers materials comprising several elements M′ in combination chosen in particular from within the same group or between different groups. More particularly, manganese can be present combined with an alkali or an alkaline earth element and still more particularly, the manganese can be combined with potassium.

According to this particular embodiment of the invention, the element M′ is present in the material in the form of a salt. In this case, the salt can in particular be a chloride, a sulphate or a carbonate.

According to another particular embodiment, the element M′ is present in the material in the form of a hydroxide or an oxide or also an oxyhydroxide.

However, the element M′ can also be present at once in the same material in the form of a salt, a hydroxide, an oxide or an oxyhydroxide.

The element M′ can finally be present in amorphous form or in crystallized form.

The crystallites can be for example crystallites of TiO₂ in anatase form, crystallites of ZrO₂.

The crystallites based on metal M′ described above generally have an average size smaller than or equal to 500 nm, preferably smaller than or equal to 200 nm. In general, these crystallites have an average size at least equal to 2 nm.

By “cluster” based on the metal M′ is meant a polyatomic entity less than 2 nm in dimension, preferably less than 1 nm, comprising at least atoms of the metal M′, in state of oxidation 0 or a higher state of oxidation (typically, these are clusters based on oxide and/or hydroxide species of the metal M′, for example polyatomic entities within which several atoms of the metal M′ are interconnected by —O— or —OH— bridges, each of the atoms of the metal M′ being able to be linked to one or more —OH groups). This variant can be used in particular in the case where the metal M′ is zirconium, manganese, or also a rare earth (in particular lanthanum, yttrium, neodymium, praseodymium, dysprosium or europium).

According to a particular variant in the case where manganese is combined with an alkali or an alkaline earth element, these elements can be present in the material of the invention in a chemically bonded form. By this is meant that there are chemical bonds between the manganese and the other element resulting from a reaction between them, these two elements not being simply juxtaposed as in a simple mixture. Thus, the elements manganese and the other element can be present in the form of a compound or a mixed-oxide-type phase. This compound or this phase can in particular be represented by the formula AₓMnyO₂₊δ (1) in which A describes the other element (alkali or alkaline earth) and 0.5≦y/x≦6. There can be mentioned as examples of the phase or compound of formula (1) those of vernadite, hollandite, romanechite or psilomelane, bimessite, todorokite, buserite or lithiophorite type. The compound can optionally be hydrated. The compound can moreover have a Cdl₂-type lamellar structure. Formula (1) is given here by way of illustration, but it would not go beyond the scope of the present invention if the compound had a different formula, provided of course that the manganese and the other element were chemically well bonded.

When the cations, clusters and/or crystallites of an alkali or alkaline earth metal are dispersed on the surface of the oxide constituting the material as has just been described, the quantity of this metal in this form, expressed in moles relative to the moles of the constitutive oxide or oxides and of metal M′, is generally comprised between 2% and 30%, preferably between 4% and 25%.

The characteristics of the compound according to the invention, more particularly the homogeneity, described in the first variant of the invention are also valid for compound according to the second variant.

In a preferred embodiment, the compound according to the invention can comprise a mineral phase of alumina within which particles of cerium, doped or not, are dispersed. In this case the alumina and cerium are present in a quantity such that the atomic ratio Ar=Al/(Ce+Al) is at most 50%, preferably at most 25%.

The compound according to the invention, doped or not, advantageously possesses a mesostructured structure the overall thickness of the walls of the compound of which is comprised between 2 and 10 nm.

The compound according to the invention, doped or not, advantageously possesses a mesoporous structure comprising pores with a size comprised between 2 and 12 nm, preferably between 3 and 9 nm.

The compound, doped or not, according to the invention is advantageously a solid which has at least locally one or more mesostructure(s) chosen from:
mesoporous mesostructures of P63/mmc three-dimensional hexagonal symmetry, P6mm two-dimensional hexagonal symmetry, Ia3d, Im3m or Pn3m three-dimensional cubic symmetry; or
vesicular or lamellar-type mesostructures,
vermicular-type mesostructures.

Regarding the definition of these different symmetries and structures, reference can be made for example to Chemical Materials, vol. 9, No. 12, pp. 2685-2686 (1997) or also to Nature, vol. 398, pp. 223-226 (1999) or also to Science Vol. 269, pp 1242-1244 (1995).

On the other hand, the compounds according to the first variant of the invention have a good temperature stability and a high specific surface area, greater than 650 m²/cm³ for a calcination temperature of 500° C. over 6 hours. This specific surface area expressed in m²/cm³ is obtained by multiplying the surface area generally measured in m²/g by the density of the composite material. For a compound the particles of nanometric dimension of which are based on a cerium compound, this specific surface area is preferably comprised between 100 and 500 m²/g.

On the other hand, the compounds according to the second variant of the invention have a good temperature stability and a high specific surface area, advantageously greater than 650 m²/cm³, preferably greater than 900 m²/cm³, and still more preferably greater than 1200 m²/cm³ for a calcination temperature of 400° C. over 6 hours. This specific surface area expressed in m²/cm³ is obtained by multiplying the surface generally measured in m²/g by the density of the composite material. For a compound the particles of nanometric dimension of which are based on a cerium compound, this specific surface area is preferably comprised between 100 and 300 m²/g.

In the particular case of a doped material constituted by a binding phase of alumina and cerium oxide particles and in which M is titanium, this surface area can be at least 100 m₂/g, more particularly at least 125 m²/g and still more particularly at least 150 m²/g.

The pore volume of the doped materials of the invention is generally at least 0.10 cm³/g, more particularly at least 0.15cm³/g and still more particularly at least 0.20 cm³/g.

One of the advantages of the materials according to the second variant of the invention based on cerium oxide particles is their reducibility. This “reducibility” of a material according to the invention can be demonstrated by treating the material with hydrogen and by analyzing the rate of conversion of the cerium in oxidation state IV initially present into cerium in oxidation state III in the material obtained after the treatment, according to the overall reaction below:
2CeO₂+H₂→Co₂03+H20

The reducible character of a doped material according to the invention can thus in particular be quantified by the rate of conversion measured at the end of what is called a “TPR” protocol, described below:
in an Altamira AMI-1-type apparatus equipped with a silica reactor, a sample of 100 mg of the solid to be tested is placed at ambient temperature (generally between 15° C. and 25° C.) under a gaseous flow of a hydrogen/argon mixture with 10% hydrogen by volume, at a flow rate of 30 mL per minute.
the temperature is increased to 900° C. at a constant temperature rise gradient of 10° C. per minute. Using a 70 mA thermal conductivity detector, the quantity of hydrogen collected by the material from the surface lacking the hydrogen signal from the base line at ambient temperature to the base line at 900° C. is determined.

At the end of such a test, a rate of conversion of the cerium IV species initially present is generally measured which is at least 30%, this conversion rate being advantageously at least 40%, more preferably at least equal to 50%.

It is to be noted moreover that the reduction peak of the cerium determined by the above protocol is centred on temperatures of at most 450° C., preferably at most 400° C. and still more preferably at most 375° C.

The process according to the invention will now be described.

The process for preparing the product according to the first variant of the invention comprises the following stages:
1) an aqueous mixture is formed comprising:
   a colloidal dispersion of alumina
   at least one texturing agent
   a colloidal dispersion of a cerium, titanium or zirconium compound in which the cerium, titanium or zirconium compound is functionalized by a surfactant of formula X-A-Y in which:
      a) X is a function that complexes the cation of the cerium, titanium or zirconium compound of the colloidal dispersion;
      b) A is a linear or branched alkyl-type group;
      c) Y is an amine or hydroxy group;

the colloidal dispersions of alumina and of the cerium, titanium or zirconium compound having a conductivity below 25 mS/cm;
2) the water is eliminated from the above-mentioned mixture;
3) the texturing agent is eliminated.

The process for preparing the product according to the second variant of the invention comprises the stages 1) to 3) previously described and also comprises, after the above-mentioned stage 3), the following stages:
4)-(a) the material obtained previously is brought into contact with a solution of the element M which has a concentration of this element of at most 2 mol/l;
   (b) the material obtained after this bringing into contact with said solution is calcined at a temperature of at most 500° C.;
   (c) if appropriate stages (a) and (b) are repeated until a material having the desired level of element M is obtained.

Advantageously the colloidal dispersions used to prepare the mixture of stage 1 are of the type of those described in particular in the patents EP 206 906 and EP 208 580 (in particular for the colloidal dispersion of cerium), or in Materials Letters 40 (1999) 52-58 (in particular for the colloidal dispersion of alumina). These dispersions can also be obtained in particular by acid treatment and washing of dispersions of ultrafine powders obtained for example by high-temperature synthesis processes of the type of combustions of metal chlorides in a flame, known to a person skilled in the art.

Preferably, the concentration of particles in the dispersions used according to the invention expressed in cation moles is greater than 1 M.

The colloidal dispersion of alumina preferably has a pH comprised between 3 and 6. Moreover it is preferable to use a colloidal dispersion of alumina the size of the particles or colloids of which is comprised between 1 nm and 5 nm.

The colloidal dispersion of a cerium, titanium or zirconium compound preferably possesses particles or colloids the average size of which is comprised between 3 nm and 8 nm.

The colloidal dispersions of alumina and of cerium, titanium or zirconium compound used are purified by washing by the ultrafiltration technique in order to have the above-mentioned level of conductivity. The conductivity value given above is for a measurement carried out on dispersions with a pH comprised between 2 and 5 and with a cation concentration of 1 M. This conductivity measured under these conditions is thus below 25 mS/cm, advantageously below 8 mS/cm.

The initial medium formed during stage (1) is an aqueous medium, but it can also be a hydro-alcoholic medium, and preferably in this case a water/ethanol medium.

The mixture prepared at the end of stage I comprises at least one texturing agent.

This texturing agent present in the mixture is a surfactant-type amphiphilic compound, in particular a copolymer. The essential characteristic of this compound is that it is capable of forming liquid crystal phases in the reaction mixture, so as to lead to the formation of a mineral matrix possessing an organized mesostructure by implementing the “LCT” (Liquid Crystal Templating) texturing mechanism.

However, in order to implement a neutral texturing process which has the advantage of leading to an increase in the thickness of the walls obtained and therefore to an improvement in the stability of the final structure, the texturing agent used in the process according to the invention is preferably a compound that is not charged under the conditions of implementation of the process.

Advantageously, the texturing agent according to the invention is a non-ionic copolymer-type surfactant, and in particular chosen from diblock or triblock-type block copolymers.

Preferably, in the case of a process carried out in aqueous or hydro-alcoholic media, a non-ionic block copolymer-type texturing agent is used, and more preferably a poly(ethylene oxide)-poly(propylene oxide)-poly(ethylene oxide) triblock copolymer known as PEO-PPO-PEO (also called (EO)ₓ-(PO)_{y}-(EO)_{z}) of the type of those described in particular by Zhao et al. in the Journal of the American Chemical Society, vol. 120, pp. 6024-6036 (1998), and marketed by BASF under the generic tradename of Pluronic®. Advantageously non-ionic surfactants can also be used, such as the grafted poly(ethylene oxides) (EO)ₓC_{y} marketed by Aldrich under the tradenames Brij® or Tween®; or also non-ionic surfactants of the sorbitan-type of those marketed by Fluka under the tradename Span®.

The texturing agent can also be a poly(ethylene oxide)-poly(isopropene) block copolymer or a poly(ethylene oxide)-poly(isoprene) block copolymer.

According to the invention the colloidal dispersion of the cerium, titanium or zirconium compound is characterized in that the cerium, titanium or zirconium compound is functionalized by a surfactant of formula X-A-Y. The surfactant can also be found in free form within the dispersion.

This surfactant is an organic compound in which A is a linear or branched alkyl group, optionally substituted, which can for example comprise from 1 to 12 carbon atoms, preferably between 2 and 8 carbon atoms.

The function X is a function that complexes the metal cation of the colloid of the colloidal dispersion of the cerium, titanium or zirconium compound. By complexing function is meant a function which allows the formation of a complexing bond between the cation of the colloid, for example the cerium cation, and the surfactant. This function can be a function of the phosphonate —PO₃²⁻, or phosphate-PO₄²⁻, carboxylate-C0₂⁻, or sulphate-So₄²⁻, sulphonate-SO₃² type for example.

The function Y is an amine or hydroxy function. It can be an amine function of —NH₂, —NHR₂, or —NR₃R₂, or —NH₄⁻, R₂ and R₃ type, identical or different, describing a hydrogen or an alkyl group comprising from 1 to 8 carbon atoms. It can also be an OH function. Among the agents with OH functions, there can for example be mentioned glycolic acid, gluconic acid, lactic acid, hydroxybenzoic acid, glycerol phosphate disodium.

Among the surfactants which are particularly suitable for the invention there can be mentioned the amino acids, and in particular the aliphatic amino acids. In particular there can be mentioned the amino acids constituting proteins with the structure R—CH(NH₂)—COOH where R is an aliphatic radical. By way of example there can be mentioned leucine, alanine, valine, isoleucine, glycine and lysine.

The preferred surfactant according to the invention is aminohexanoic acid.

Advantageously the quantity of surfactant used to functionalize the compound of this dispersion is expressed by the Rb ratio, determined by the following formula:

$$Rb = \frac{Number of moles of function X}{\begin{matrix}Number of moles of cerium , \\ titanium or zirconium oxide\end{matrix}}$$

The Rb ratio is advantageously comprised between 0.1 and 0.5.

Preferably, the functionalization of the cerium, titanium or zirconium compound is carried out by bringing a dispersion of said compound into contact with the surfactant.

According to a preferred variant of the invention, the starting colloidal dispersion of alumina can also be a dispersion in which the colloids of alumina can be functionalized by a surfactant of the X-A-Y type, identical to or different from the surfactant of the colloidal dispersion of the cerium, zirconium or titanium compound.

Preferably, an elimination of any free surfactant molecules is carried out by ultrafiltration washing.

The formation of the mixture of stage 1) of the process according to the invention is carried out by simply bringing into contact the constituents of the mixture, namely the dispersion of alumina, the texturing agent and the colloidal dispersion functionalized according to the method described above. This simple bringing into contact takes place in aqueous or hydroalcoholic media.

The conditions for implementing stage 1) are such that they make it possible to obtain at the end of stage 1) a mixture which possesses a conductivity (measured at a cation concentration of 1M) which is advantageously at most 25 mS/cm. Preferably the conductivity of the mixture (measured under the same conditions) will be at most 8 mS/cm.

In order to obtain such a conductivity, colloidal dispersions having this conductivity will be chosen.

The colloidal dispersions and the texturing agent are used in quantities such that the ratio:

$$ϕ = \frac{volume of the colloids}{volume of the colloids + volume of the texturing agent}$$

is preferably comprised between 0.1 and 0.6, and more particularly between 0.1 and 0.4.

By volume of the colloids is meant the value obtained by dividing the mass of the colloids present in the dispersion or dispersions by the theoretical density of the colloid or colloids, and by volume of the texturing agent is meant the value obtained by dividing the mass of the texturing agent by the theoretical density of the latter.

The second stage of the process consists of at least partially eliminating the water from the starting mixture. This stage can be carried out by evaporation in the open air or under a fume hood, and preferably at ambient temperature. The evaporation can advantageously be carried out in a thin layer, with a thickness of less than 5 mm. High-temperature freeze-drying can also be carried out.

The third stage of the process for preparing the compound of the invention consists of eliminating the texturing agent.

This stage can be in particular be carried out by a heat treatment. In this case, the heat treatment is advantageously carried out in accordance with a temperature rise profile comprised between 0.2° C. per minute and 3° C. per minute, and preferably following a temperature rise profile comprised between 0.5° C. per minute and 2° C. per minute, so as not to degrade the material. This temperature increase is generally carried out up to a temperature allowing the elimination of the texturing agent, preferably up to a temperature comprised between 300° C. and 600° C.

On the other hand, the elimination of the texturing agent can also be carried out by entrainment by a solvent. It is to be noted that the entrainment by a solvent is facilitated by the fact that a non-charged amphiphilic compound is preferably utilised, which induces a texturing agent-matrix interaction weak enough to allow this type of elimination.

Advantageously, the solid obtained at the end of stage 3 can moreover be subjected to an additional heat treatment, and in particular to a calcination. The aim of this optional additional heat treatment is to increase the crystallinity of the material obtained, and eliminate impurities such as nitrate anions and surfactants.

The fourth stage of the process consists of bringing the material obtained in the preceding stages of the process into contact with a solution of the element M.

The solution of the element M used in the case of the process according to the invention is usually an aqueous solution based on salts of this element. The salts of inorganic acids such as nitrates, sulphates or chlorides can be chosen. The salts of organic acids and in particular the salts of saturated aliphatic carboxylic acids or the salts of hydroxycarboxylic acids can also be chosen. By way of examples, there can be mentioned formates, acetates, propionates, oxalates or citrates. It is however possible to use an aqueous or hydro-alcoholic solution comprising cations. of the metal M in the complexed state, or also a solution, generally in anhydrous organic solvent medium, comprising an alkoxide of the metal M.

When the element M is titanium, a titanium alkoxide in acidified hydroalcoholic medium can more particularly be used.

The solution which is brought into contact with the material has a concentration of this element M which is at most 2M, preferably at most 1.2M. A higher concentration risks preventing the formation of a solid solution of the element M in the oxide constituting the particle.

The bringing into contact can be done by immersing the starting mesostructured material within a solution comprising the element M then subjecting the medium obtained to a centrifugation. Generally, the centrifugation is carried out at 2000 to 5000 rpm, for a period generally not exceeding 30 minutes.

According to a particular embodiment, the bringing into contact of the element M with the cerium, titanium or zirconium compound is done by dry impregnation. The dry impregnation consists of adding to the product to be impregnated a volume of an aqueous solution of the element M which is equal to the pore volume of the material to be impregnated.

The solid obtained at the end of phase (a) of the fourth stage of the process is then subjected to a calcination. This calcination stage (phase (b) of the fourth stage) is essentially intended to realize an at least partial integration of cations of the element M in solid solution within the oxide constituting the particle. To this end, this calcination takes place at a temperature at least equal to 300° C., this temperature being preferably at least equal to 350° C. but it is preferably at most 400° C. and advantageously at most 500° C. Higher temperatures are not required for the integration of the cations of the element M within the oxide of the particle. In this connection, it must be stressed that the process of the present invention surprisingly makes it possible to integrate metal cations in solid insertion and/or substitution solution within the metal oxide of the particle at low temperatures, which in particular makes it possible to obtain mesostructured materials having very large specific surface areas. In particularly advantageous fashion, the calcination stage can be carried out by subjecting the solid to a temperature gradient, from an initial temperature comprised between 15 and 95° C., to a final temperature comprised between 350° C. and 1000° C., advantageously with a temperature rise comprised between 0.5° C. per minute and 2° C. per minute, and with one or more intermediate temperature holding stages, preferably comprised between 350 and 600° C., for variable periods, generally comprised between 1 hour and 24 hours. Optionally, the preparation process of the invention can comprise a drying stage, prior to the calcination stage 4) (b). In this case, this prior drying is generally carried out as slowly as possible, in particular so as to promote ion exchanges. To this end, the drying is most often carried out at a temperature comprised between 15 and 80° C., preferably at a temperature below 50° C., or even below 40° C., and advantageously at ambient temperature. This drying can be carried out under an inert atmosphere (nitrogen, argon) or under an oxidizing atmosphere (air, oxygen) depending on the compounds present in the material. In the case where the metal M is introduced into the material in the form of an alkoxide, the drying is advantageously carried out under a water-free atmosphere.

According to a particularly advantageous embodiment, the process of the invention can comprise, following stages 4) (a) and 4) (b), one or more subsequent cycles of bringing into contact/calcination implementing stages of type 4) (a) and 4) (b), carried out on the solid obtained at the end of the preceding cycle. By implementing this type of process with several successive cycles of bringing into contact/calcination, a very good incorporation of the element M in solid solution within the particles of oxides is achieved. These cycles are repeated until a material having the desired level of element M is obtained. It is also possible to envisage the implementation of several cycles of bringing into contact/calcination using separate M-type doping elements, whereby it is possible to obtain materials constituted by oxides doped with several metal elements in solid solution.

To prepare materials according to the variant described above in which cations, clusters and/or crystallites of the metal M′ or of an alkali or alkaline earth metal are dispersed on the surface of the oxide constituting the material, solutions of this element (M′ or alkalis or alkaline earths) are used at high concentrations, for example at least 1.5M and/or the stage of bringing into contact with this solution is repeated after saturation of the oxide constituting the material in the form of solid solution with this element . The process for preparing these materials, containing M′, is the same as that described for the preparation of the materials containing the element M and comprises the stages 1, 2, 3 and 4 described above.

Finally the invention also relates to the use of the ordered mesoporous or mesostructured compound according to the invention and of the product obtained by the process according to the invention as a catalyst or catalyst support in particular for automobile post-combustion.

The following examples illustrate the invention without however limiting its scope.

### EXAMPLES

### Example 1

### Preparation of a Compound of Cerium Nanoparticles in a Matrix of Alumina Al₂—O₃ With an (Al/Ce) Ratio=(0.1/0.9) Mole et φ=0.2

1-a) Preparation of an Aqueous Colloidal Dispersion of Crystallized Cerium Oxide Particles of Nanometric Dimensions:

A colloidal dispersion of cerium oxide is prepared following the procedure described in Example 1 of patent application EP 208 580. The cerium hydrate content is 65% by mass. 300 g of demineralized water is added to 500 g of redispersable cerium hydrate. An Ultraturax dispersion is then carried out for 15 minutes at 4500 rpm. The dispersion is centrifuged for 15 minutes at 4500 rpm. A moist pellet is recovered. 200 g of demineralized water is added to this moist pellet, the total volume of the dispersion after addition of water being 300 ml. After Ultraturax homogenization for 15 minutes, the dispersion is centrifuged for 45 minutes at 4500 rpm. A pellet is recovered. Demineralized water is again added to this moist pellet up to a total volume of 600 ml. After homogenization, a colloidal dispersion clear to the eye is obtained that is concentrated by ultrafiltration to 330 ml. This is taken up in demineralized water up to a volume of 600 ml. This is concentrated to 200 ml.

After determination of the loss by combustion of the dispersion of density 1.92, the molar concentration of Ce0₂ is 5.69 M or 2.95 mol/kg.

The functionalization of the surface of the CeO₂ nanoparticles is carried out as follows:

A solution prepared by adding 30.92 g of aminohexanoic acid into 400 ml of water is added to 400 g of colloidal dispersion prepared as described previously. This is left under stirring at ambient temperature for 16 hours. The pH is 4.6. The dispersion is again washed by ultrafiltration by adding two equivalent volumes of demineralized water. This is concentrated to 500 ml. The dispersion thus obtained is 2.08 mol/l.

After dilution with 1 M/l demineralized water, the pH of the dispersion is 4.3 and the conductivity of the dispersion is 3.15 mS/cm.

1-b) Preparation of an Aqueous Colloidal Dispersion of Particles of Aluminium Trihydroxide (Al (OH)₃) of Nanometric Dimensions:

A colloidal dispersion of aluminium trihydroxide is prepared according to the procedure described below:

In a double-envelope reactor equipped with a stirring system and a condenser, 121 g of aluminium salt AlCl₃, 6H₂O are added to 150 g of water under stirring,. After dissolution, 154 ml of 3.25 M NH₄OH is added at 5 ml/minute at ambient temperature. Then 45 g of urea previously dissolved in 50 g of water is added.

The reaction medium is maintained at 95° C. for 16 hours.

After cooling to ambient temperature, the pH is pH 6.09.

The dispersion is transferred into a beaker equipped with a pH electrode connected to a pH adjustment device. Hydrochloric acid is added under stirring over an hour in order to adjust the pH of the dispersion to pH 4. This is left under stirring for another hour.

The dispersion is washed with 4 times its volume of demineralized water by ultrafiltration on 3 KD membranes.

The dispersion is concentrated by ultrafiltration and determination of the dry extract by calcination of an aliquot at 1000° C. indicates a concentration of 1.1 mole in Al.

The concentration of the 1 M dispersion in Al is adjusted by dilution with demineralized water.

The pH is equal to 4.65 and the conductivity is 4.5 mS/cm. Using transmission electron cryomicroscopy, fully individualized nanoparticles with a diameter of 3 nm are viewed.

1-c) Preparation of the Mesostructured Material:

200 g of water, then 6.10 g of Pluronic P 123 are poured into a beaker. This Pluronic P 123 compound is an amphiphilic copolymer of tri-block block type from the company BASF having as structural formula HO(CH₂CH₂0)₂₀(CH₂CH (CH₃)O)₇₀(CH₂CH₂0)₂₀H and an average molecular mass of 5750 g/mole. The mixture produced was thus subjected to stirring for two hours. There followed the simultaneous addition of 56.3 ml of the 1 M cerium oxide colloidal dispersion previously described and 6.3 ml of the 1 M aluminium trihydroxide colloidal dispersion previously described. The stirring was continued for 15 minutes.

The dispersion obtained was then placed in glass Petri dishes and subjected to evaporation at 20° C. for 5 days under a fume hood.

The dry product was then transferred into alumina combustion boats. The product was calcined at 500° C. with a temperature rise of 1° C./minute and a stage of 6 hours.

The quantities of amphiphilic copolymer and colloidal dispersion thus used verify the φ ratio=0.2.

Transmission electron microscopy observation of the material obtained at the end of these different stages shows the existence of a texture.

Moreover, the line of the nitrogen BET adsorption-desorption curves show a monodisperse pore-size distribution.

The specific surface area of the material was determined as being equal to 200 m²/g for the product calcined at 400° C. for 6 hours, i.e. 1360 m²/cm³.

The specific surface area of the material was determined as being equal to 158 m²/g for the product calcined at 500° C. for 6 hours, i.e. 1075 m²/cm³.

The specific surface area of the material was determined as being equal to 110 m²/g for the product calcined at 600° C. for 6 hours i.e. 748m²/cm³.

Moreover, the average pore size for these different products was determined as being equal to 7 nm.

The pore volume determined by nitrogen BET is νₚ=0.33 cm³/g. Using X-ray diffraction, streaks characteristic of the Ce0₂ structure were observed.

### Example 2

### Preparation of a Compound of Cerium Nanoparticles in a Matrix of Alumina Al₂O₃—CeO₂ with an (Al/Ce) Ratio=(0.25/0.75) Mole and φ=22

200 g of water, then 6.10 g of Pluronic P 123 were poured into a beaker. The mixture produced was thus subjected to stirring for two hours. There followed the simultaneous addition of 52.2 of the 1 M cerium oxide colloidal dispersion previously described and 17.4 ml of the 1 M aluminium trihydroxide colloidal dispersion previously described. The stirring was continued for 15 minutes.

The dispersion obtained was then placed in glass Petri dishes and subjected to evaporation at 20° C. for 4 days under a fume hood.

The dry product was then transferred into alumina combustion boats. The product was calcined at 500° C. with a temperature rise of 1° C./minute and a stage of 6 hours.

The quantities of amphiphilic copolymer and colloidal dispersion thus used verify the φ ratio=0.22.

Transmission electron microscopy observation of the material obtained at the end of these different stages shows the existence of a texture.

The specific surface area of the material was determined as being equal to 127 m²/g at 500° C. i.e. 784 m²/cm³.

Moreover, the average pore size was determined as being equal to 9 nm.

The pore volume determined by nitrogen BET is νₚ=0.325 cm³/g.

### Example 3

### Preparation of a Zirconium-doped Mesostructured Material: Zr-doped Al(OH)3—CeO₂

A 1.2 M solution of Zr(NO₃)₃ in Zr is prepared by adding demineralized water to 54.8 ml of 2.19 M solution of Zr(NO₃)₃ in Zr, of density 1.368 and 270 g/l zirconium oxide content, until a final volume of 100°cm³ is obtained. 12 g of the mesoporous product, obtained in Example 1-c) above, Al(OH)₃—Ce0₂(((Al:Ce)ₘₒₗₑ=(0.1:0.9) i.e. 66 millimoles of Ce and 7.2 millimoles of Al), calcined at 400° C. for 6 hours with 8.16 cm³ of solution is impregnated with the 1.2 M solution of zirconium nitrate in Zr previously prepared (i.e. 9.8 millimoles of Zr). The molar ratio (Zr/Ce) is then equal to 0.15. The product is dried at ambient temperature for 16 hours, then at 80° C. for 8 hours. The product is then calcined under air atmosphere at 400° C. with a temperature rise of 1° C./minute and a stage of 6 hours.

The impregnation and heat treatment operation is then repeated. The final molar ratio (Zr/Ce) is then equal to 0.3.

Using X-ray diffraction, a spectrum of the particle is observed which is very close to that of pure cerium oxide, with peaks shifted very slightly towards small distances (mesh parameters of 5.40 A°) and the presence of quadratic ZrO2 in very small proportions.

By plotting the adsorption-desorption isotherms, the specific surface area is determined as being equal to 125 m²/g.

A pore distribution centred on a pore diameter of 8 nm is observed.

The pore volume is determined as being equal to 0.26 cm³/g.

According to the TPR test, a reducibility peak is observed at a very low temperature centred on a temperature of 350° C. The integrated reducibility percentage up to 700° C. is 64%.

### Example 4

### Preparation of a Praseodymium-Doped Mesostructured Material: Pr-doped Al (OH)₃—CeO₂

A 1.21 M solution of Pr(NO₃)₃ in Pr is prepared by adding demineralized water to 51.9 ml of 2.91 M solution of Pr(NO₃)₃ in Pr, of density of 1.73 and 28.6% praseodymium oxide content, from the company Rhodia Terres Rares, until a final volume of 125 cm³ is obtained.

10 g of the mesoporous product, obtained in Example 1-c) above, Al(OH)₃—Ce0₂(((Al:Ce)ₘₒₗₑ=(0.1:0.9) i.e. 55 millimoles of Ce, and 6 millimoles of Al), calcined at 400° C. for 6 hours with 6.8 cm³ of solution is impregnated with the 1.21 M solution of praseodymium nitrate in Pr previously prepared (i.e. 8.23 millimoles of Pr). The molar ratio (Pr/Ce) is then equal to 0.15. The product is dried at ambient temperature for 16 hours, then at 80° C. for 8 hours. The product is then calcined under air atmosphere at 400° C. with a temperature rise of 1° C./minute and a stage of 6 hours.

The impregnation and heat treatment operation is then repeated. The final molar ratio (Pr/Ce) is then equal to 0.3.

Using X-ray diffraction, a spectrum of the particle is observed which is very close to that of pure cerium oxide, with peaks shifted very slightly towards large distances (mesh parameters of 5.45 A°).

By plotting the adsorption-desorption isotherms, the specific surface area is determined as being equal to 112 m²/g.

A pore distribution centred on a pore diameter of 7 nm is observed. The pore volume is determined as being equal to 0.0.29 cm³/g.

### Example 5

### Preparation of a Titanium-Doped Mesostructured Material: Ti-doped Al (OH)₃—CeO₂

An acidified solution of butyl titanate is prepared by dissolving 20.65 g of 23.45% Ti(OBu)₄ in TiO₂ in 15 cm³ of ethanol, and 8 cm³ of 15 M HNO₃ which are made up to 50 cm³ with ethanol.

4 g of the mesoporous product, obtained in Example 1-c) above, Al(OH)₃—Ce0₂(((Al:Ce)ₘₒₗₑ=(0.1:0.9) i.e. 22 millimoles of Ce), calcined at 400° C. for 6 hours with 2.72 cm³ of solution is impregnated with the titanium solution previously prepared (i.e. 3.26 millimoles of Pr). The molar ratio (Pr/Ce) is then equal to 0.15. The product is dried at ambient temperature for 16 hours, then at 80° C. for 8 hours. The product is then calcined under air atmosphere at 400° C. with a temperature rise of 1° C./minute and a stage of 6 hours.

Using X-ray diffraction, a spectrum of the particle is observed which is very close to that of pure cerium oxide, with peaks shifted very slightly towards small distances.

By plotting the adsorption-desorption isotherms, the specific surface area is determined as being equal to 165 m²/g.

A pore distribution centred on a pore diameter of 7 nm is observed.

The pore volume is determined as being equal to 0.32 cm³/g.

### Example 6

### Preparation of Mesostructured Material Ce-Doped Al(OH)₃—ZrO₂

6-a) Preparation of the Dispersion of Al(OH)₃:

A colloidal dispersion of Al(OH)₃ prepared following the procedure described in Example 1-a) except that dilution is to 0.57 mol/kg.

The characteristics of the colloidal dispersion obtained are:
Concentration 0.57 mole/kg in Al
Conductivity=11.2 mS/cm
pH=4.7
   6-b) Preparation of the Colloidal Dispersion of ZrO₂ Modified by Caproic Acid:

A colloidal dispersion of ZrO₂, from Nyacol, containing 20% by weight Zr0₂, density 1.32, at 2.15 mol/l is ultrafiltrated on a 3KD membrane. After washing with 6 volumes of water, the colloidal dispersion has the following characteristics: pH 1.84, conductivity 17 mS/cm, concentration 1.46 mol/l Zr0₂. The colloids possess a diameter of approximately 3 nm.

100° cm³ of colloidal dispersion of colloids of ZrO₂ modified with a 1 M caproic amine are prepared by mixing:
68.49 cm³ of 1.46 M dispersion (i.e. 100 millimoles of Zr),
31.51 cm³ of a solution containing 3.935 g of aminocaproic acid (i.e. 30 millimoles of caproic acid, MW=131 g).

This is left under stirring for 30 minutes and allowed to rest for 16 hours at ambient temperature.

The dispersion is ultrafiltrated on a 3 KD membrane by 2 equivalent volumes of water.

The characteristics of the colloidal dispersion are: pH 4.28, s=10.25 mS/cm and 0.8 mol/kg in Zr.

6-c) Preparation of the Mesostructured Material Al(OH)₃—Zr0₂ (Al:Zr)=(0.1:0.9) Mole by Self-Assembly of the Nanoparticles:

The following are mixed at ambient temperature:
55.15 g of the colloidal dispersion of ZrO₂ modified with aminocaproic acid at 0.8 mol/kg (containing 45 millimoles of Zr)
8.596 g of Al(OH)₃ sol at 0.57 mole of Al/kg (containing 5 millimoles of Al)
81.6 cm³ of a 50 g/l POE PPO POE (P123) solution (containing 4.08 g of P123).

This is left under stirring for 30 minutes.

The mixed dispersion is poured into thin-film crystallizing dishes approximately 1 cm thick. It is then left to evaporate at ambient temperature for 4 days. The solid product is calcined at 400° C. The temperature rise is 1° C./minute and the 400° C. stage lasts 6 hours.

The product obtained possesses a vermicular-type structure, shown by transmission electron microscopy.

The specific surface area is 186 m²/g. BET analysis shows a monodisperse pore distribution centred on 6 nm and a pore volume of the order of 0.22 cm³/g. Using X-ray diffraction, streaks are observed showing a commencement of ZrO₂ crystallisation corresponding to the tetragonal structure.

6-d) Doping of the Mesostructured Product Obtained in Example 6-c) with Cerium (Ce)

A 0.64 M Ce⁴⁺ impregnation solution is prepared by dilution with demineralized water to a final volume of 200 cc of an aliquot of 68.8 cm³ of ceric nitrate solution, (Rhodia La Rochelle, characteristics Ce(NO₃)₄, (H+/Ce) mole=0.5 and 1.86 M Ce⁴⁺).

118.5 g of mesostructured product (0.9 ZrO₂-0.1 Al(OH)₃) contain 0.9 mole of Zr0₂ and 0.1 mole of Al(OH)₃. 1 g of mesostructured product (0.9 ZrO₂-0.1 Al (OH)₃) contains 7.6 millimoles of Zr and 0.84 millimole of Al.

The impregnation is carried out with 0.59 cm³ of Ce(N0₃)₄ solution (i.e. 0.38 millimole of Ce⁴⁺) previously described per gram of nanostructured product. This impregnation is carried out by kneading the paste at ambient temperature. The Ce/Zr molar ratio=0.05.

The reaction medium is left to dry at ambient temperature for 16 hours then calcined at 400° C. for 6 hours. The temperature rise is 1° C./minute.

The impregnation, drying and calcination operations are repeated three times. The Ce/Zr molar ratio=0.2.

Using X-ray diffraction, a Zrl₁₋ₓCeₓO₂ structure and a minority quantity of Ce0₂ are shown.

6-e) “TPR” Evaluation

Using the “TPR” protocol described above, two reducibility peaks are observed, corresponding to maximum temperatures of approximately 375° C. (majority peak) and a second (minority) peak towards 550° C. It will be recalled that the cerium-doped ZrO₂ materials develop a reducibility peak observed at 550° C.

A reducibility percentage between 200° C. and 650° C. of 80%, large in comparison to the reducibility percentages normally found, is determined for the cerium-doped ZrO₂ products.

1-34. (canceled)

35. An ordered mesoporous or mesostructured compound comprising a mineral phase of alumina, within which at least partially crystalline particles of a cerium, titanium or zirconium compound are dispersed, and having a chemical homogeneity such that the heterogeneity domains are at most 100 nm².

36. The compound according to claim 35, having a chemical homogeneity such that the heterogeneity domains are at most 25 nm².

37. The compound according to claim 35, further having an overall degree of crystallinity by volume of at least 10%.

38. The compound according to claim 37, wherein the overall degree of crystallinity by volume is of at least 30%.

39. The compound according to claim 35, wherein the particles are particles of cerium and wherein the alumina and the cerium are present in a quantity providing an atomic ratio Ar=Al/(Ce+Al) of at most 50%, optionally at most 25%.

40. The compound according to claim 35, having walls whose overall thickness is comprised between 2 and 10 nm.

41. The compound according to claim 35, wherein the particles dispersed in the mineral phase present a diameter of 3 nm to 5 nm.

42. The compound according to claim 35 having pores with a size comprised between 2 and 12 nm.

43. The compound according to claim 35, having at least locally a mesostructure selected from the group consisting of mesoporous mesostructure of P63/mmc three-dimensional hexagonal symmetry, P6mm two-dimensional hexagonal symmetry, Ia3d, Im3m or Pn3m three-dimensional cubic symmetry; vesicularmesostructure; lamellar mesostructure; or vermicular mesostructure.

44. The compound according to claim 35, wherein the particles include at least one element M in solid solution in said particles.

45. The compound according to claim 44, wherein said element M is selected from the rare earths and the transition metals, and is capable of being integrated in cationic form in solid solution within said particles.

46. The compound according to claim 45, wherein said element M is cerium, titanium, zirconium, manganese, lanthanum, praseodymium or neodymium, with the proviso that said element M is different from the element cerium, titanium or zirconium constituting said particle.

47. The compound according to claim 46, comprising particles of a cerium compound and wherein the element M is a rare earth or zirconium, with a molar ratio M/Ce of at most 1.

48. The compound according to claim 46, comprising particles of a cerium compound and wherein the element M is titanium with a molar ratio Ti/Ce of at most 0.5.

49. The compound according to claim 35, wherein said particles further comprise at least one element M′ at least in part on their surface.

50. The compound according to claim 49, wherein the element M′ is manganese, an alkali metal or an alkaline earth metal.

51. A process for the preparation of an ordered mesoporous or mesostructured compound comprising a mineral phase of alumina, within which at least partially crystalline particles of a cerium, titanium or zirconium compound are dispersed, and having a chemical homogeneity such that the heterogeneity domains are at most 100 nm², said process comprising the steps of:
1) forming an aqueous mixture comprising a colloidal dispersion of alumina; at least one texturing agent; a colloidal dispersion of a cerium, titanium or zirconium compound in which the cerium, titanium or zirconium compound is functionalized by a surfactant of formula:
X-A-Y
wherein:
X is a function that complexes the cation of the cerium, titanium or zirconium compound of the colloidal dispersion;
A is a linear or branched alkyl-type group; and
Y is an amine or hydroxy group;
the colloidal dispersions of alumina and of the cerium, titanium or zirconium compound having a conductivity below 25 mS/cm;
2) eliminating the water from the mixture formed in step 1);
3) eliminating the texturing agent; and
4) recovering the mesoporous or mesostructured compound.

52. The process according to claim 51, wherein the colloidal dispersion of alumina has a pH of between 3 and 6.

53. The process according to claim 52, wherein the colloidal dispersion of alumina has a size of colloids of between 1 and 5 nm.

54. The process according to claim 51, wherein the texturing agent is a non-ionic copolymer surfactant.

55. The process according to claim 54, wherein the copolymer is a poly(ethylene oxide)-poly(propylene oxide)-poly(ethylene oxide) triblock copolymer, a poly(ethylene oxide)-poly(isopropene) block copolymer or a poly(ethylene oxide)-poly(isoprene) block copolymer.

56. The process according to claim 51, wherein the colloidal dispersion of a cerium, titanium or zirconium compound is a colloidal dispersion of a cerium, titanium or zirconium oxide and the surfactant are present with a Rb ratio (Rb=number of moles of function X/number of moles of cerium, titanium or zirconium oxide), of between 0.1 and 0.5.

57. The process according to 51, wherein the colloidal dispersion of a cerium,. titanium or zirconium compound present colloids whose average size is between 3 and 8 nm.

58. The process according to one of claim 51, wherein the surfactant is an amino acid, optionally an aliphatic amino acid.

59. The process according to claim 51 wherein, in step 1), the mixture has a conductivity, measured at a concentration of 1 M, of at most 25 mS/cm.

60. The process according to claim 59, wherein the conductivity is at most 8 mS/cm.

61. The process according to one of claims 17 to 26 wherein the colloidal dispersions and the texturing agent are in quantities such that the ratio Φ (Φ=volume of the colloids/volume of the colloids+volume of the texturing agent) is between 0.1 and 0.6, optionally between 0.1 and 0.4.

62. The process according to claim 51, wherein in step 2), the water is eliminated from the mixture formed in step 1), by evaporation or by spray-drying.

63. The process according to claim 51, wherein in step 3), the texturing agent is eliminated by a heat treatment.

64. The process according to claim 51, wherein in step 1), the functionalization of the cerium, titanium or zirconium compound is carried out by adding a colloidal dispersion of said compound to the surfactant.

65. A process for the preparation of an ordered mesoporous or mesostructured compound comprising a mineral phase of alumina, within which at least partially crystalline particles of a cerium, titanium or zirconium compound are dispersed, and having a chemical homogeneity such that the heterogeneity domains are at most 100 nm², said particles including at least one element M in solid solution in said particles, said element M being selected from the rare earths and the transition metals, and being capable of being integrated in cationic form in solid solution within said particles, said process comprising the steps of:
1) forming an aqueous mixture comprising a colloidal dispersion of alumina; at least one texturing agent; a colloidal dispersion of a cerium, titanium or zirconium compound in which the cerium, titanium or zirconium compound is functionalized by a surfactant of formula:
X-A-Y
wherein:
X is a function that complexes the cation of the cerium, titanium or zirconium compound of the colloidal dispersion;
A is a linear or branched alkyl-type group; and
Y is an amine or hydroxy group;
the colloidal dispersions of alumina and of the cerium, titanium or zirconium compound having a conductivity below 25 mS/cm;
2) eliminating the water from the mixture formed in step 1);
3) eliminating the texturing agent; and
4) recovering said compound by:
4-a) adding the mixture obtained at the end) of step 3), to a solution of an element M selected from the rare earths and the transition metals, being capable of being integrated in cationic form in solid solution within said particles and having a concentration of this element of at most 2 mol/l;
4-b) calcining the mixture obtained at the end of step 4-a) at a temperature of at most 500° C.; and, optionally,
4-(c) repeating steps 4-a) and 4-b) until obtaining the compound with a desired level of element M.

66. The process according to claim 65, wherein the step 4-a) is done by dry impregnation.

67. A process for the preparation of an ordered mesoporous or mesostructured compound comprising a mineral phase of alumina, within which at least partially crystalline particles of a cerium, titanium or zirconium compound are dispersed, and having a chemical homogeneity such that the heterogeneity domains are at most 100 nm², said particles comprising at least one element M′ at least in part on their surface,
said element M′ being manganese, an alkali metal or an alkaline earth metal, said process comprising the steps of:
1) forming an aqueous mixture comprising a colloidal dispersion of alumina; at least one texturing agent; a colloidal dispersion of a cerium, titanium or zirconium compound in which the cerium, titanium or zirconium compound is functionalized by a surfactant of formula:
X-A-Y
wherein:
X is a function that complexes the cation of the cerium, titanium or zirconium compound of the colloidal dispersion;
A is a linear or branched alkyl-type group; and
Y is an amine or hydroxy group;
the colloidal dispersions of alumina and of the cerium, titanium or zirconium compound having a conductivity below 25 mS/cm;
2) eliminating the water from the mixture formed in step 1);
3) eliminating the texturing agent; and
4) recovering said compound by:
4-a′) the material obtained previously is brought into contact with a solution of the element M′ which has a concentration of this element of at least 1.5 mol/l;
4-b′) the material obtained after this bringing into contact with said solution is calcined at a temperature of at most 500° C.; and, optionally,
4-c′) repeating seps 4-a′) and 4-b′) until obtaining the compound with a desired level of element M′.

68. A catalyst support in particular for automobile post-combustion, comprising a compound as defined in claim 35.
